(19) United States
(12) Patent Application Publication
(10) Pub. No.: US 2012/0296483 A1
(43) Pub. Date: Nov. 22, 2012

(54) METHOD FOR DIAGNOSIS OF INCORRECTLY SET ENERGY SUPPLY PARAMETERS OF A FIELD DEVICE POWER SUPPLY MODULE

(75) Inventors: Christian Seiler, Auggen (DE); Marc Fiedler, Reinach (CH); Stefan Probst, Weil am Rhein (DE)

(73) Assignee: Endress + Hauser Process Solutions AG, Reinach (CH)

(21) Appl. No.: 13/513,379

(22) PCT Filed: Nov. 8, 2010
(86) PCT No.: PCT/EP10/66979

§ 371 Date: Aug. 10, 2012

(30) Foreign Application Priority Data
Dec. 4, 2009 (DE) 10 2009 047 542.7

(51) Int. Cl. G05F 5/00

(52) U.S. Cl. 700/292; 700/286

(57) ABSTRACT

A method for the diagnosis of incorrect settings of energy supply parameters of a field device power supply module, which is connected to exclusively one field device and by which the one connected field device is supplied with electrical energy. In the method, the system comprising field device power supply module and connected field device is operated with set energy supply parameters of the field device power supply module. In such case, the manner of operation of the connected field device is automatedly monitored by the field device power supply module to look for occurring malfunctions. Defective settings of energy supply parameters are automatedly diagnosed by analyzing occurring malfunctions and associated these with incorrectly set energy supply parameters based on predetermined rules.

The present invention relates to a method for diagnosis of incorrect settings of energy supply parameters of a field device power supply module. The field device power supply module is, in such case, connected to exclusively one field device and includes an electrical energy source or is connected to such. The field device power supply module supplies the one connected field device with electrical energy.

In process automation technology, field devices are often applied for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a section of pipeline, or the fill level in a container, can be changed. Especially such sensors and actuators are referred to as field devices. A large number of such field devices are available from the firm, Endress+Hauser.

In modern industrial plants, field devices are, as a rule, connected with superordinated units via bus systems (Profibus®, Foundation® Fieldbus, HART®, etc.). Normally, the superordinated units are control systems, or control units, such as, for example, PLCs (programmable logic controllers). The superordinated units serve, among others, for process control, process visualizing, process monitoring as well as for, start-up of the field devices. The measured values registered by the field devices, especially sensors, are transmitted via the particular bus system to one (or, in given cases, a number of) superordinated unit(s). Along with that, also required is data transmission from the superordinated unit via the bus system to the field devices, especially for configuring and parametering the field devices as well as for operating actuators.

Besides wired data transmission between the field devices and a superordinated unit, there is also the opportunity for wireless data transmission. For implementing wireless data transmission, newer field devices are, in part, embodied as radio field devices. These have, as a rule, a radio unit as an integral component. Furthermore, they can also have an integrated electrical current source, such as, for example, a single-use battery, so that they are operable autarkically.

Along with that, there is also the opportunity to turn field devices without a radio unit (i.e. with only a wired communication interface), and without their own electrical current source, into a radio field device, by connecting a wireless adapter, which has a radio unit. For example, the publication WO 2005/103851 A1 describes a wireless adapter. In such case, a wireless adapter is preferably embodied in such a manner that it also enables energy supply (or electrical current supply) of the connected field device. In the latter case, the wireless adapter simultaneously forms a field device power supply module.

Similarly as in a field device, also in a wireless adapter, a number of parameters are provided. In part, these are preset by the manufacturer of the wireless adapter and/or can be set by a user, especially changed, activated and/or deactivated. The parameters of the wireless adapter are, as a rule, stored in a memory of the wireless adapter. In this way, a corresponding control unit (e.g. a microprocessor) of the wireless adapter can access these parameters and operate the wireless adapter corresponding to the parameter settings. The respective parameter settings determine, in such case, the manner of operation of the wireless adapter.

In case the wireless adapter can also provide an energy supply (or electrical current supply) of the connected field device, i.e. the wireless adapter is also embodied as a field device power supply module, then provided in the wireless adapter are corresponding parameters. These parameters enable settings relative to the energy supply (or electrical current supply) of the field device. These parameters are referred to in the following as energy supply parameters of the wireless adapter. As a function of the field device type connected to the wireless adapter, there are different requirements relative to the energy supply by the wireless adapter. Depending on field device type of the connected field device, thus, corresponding settings of the energy supply parameters must be performed, in order to be able to assure an optimal, or at least sufficient, energy supply by the wireless adapter for the respectively connected field device.

In such case, there is the danger that such energy supply parameters get incorrectly set (for example, by a user). This can lead to situations where, due to an insufficient energy supply, for example, malfunctions occurs in the field device, such as, for example, a restart of the same, an improper start-up, etc. To the user, in such case, the source of the malfunction is not recognizable. Especially, it is not recognizable that the arisen error was caused by an energy supply not meeting the demands of the field device type as a result of incorrectly set energy supply parameters. Accordingly, a user must consider a large number of possible causes in the case of the particular field device and/or in the case of the wireless adapter and, in given cases, call-in a service specialist (e.g. of the manufacturer of the wireless adapter), in order to figure the malfunction out. This is associated with high costs and effort.

Accordingly, an object of the present invention is to provide a method, which facilitates for a user of a system comprising a field device and a thereto connected, field device power supply module, especially one in the form of a wireless adapter, a defect diagnosis with reference to malfunctions of the field device.

The object is achieved by the features of a method as defined in claim 1 as well as a field device power supply module as defined in claim 15. Advantageous further developments of the invention are set forth in the dependent claims.

The present invention provides a method for diagnosis of incorrect settings of energy supply parameters of a field device power supply module. The field device power supply module is, in such case, connected to exclusively one field device (especially a sensor or an actuator). Furthermore, field device power supply module includes an electrical energy source or is connected to such and the one connected field device is supplied by the field device power supply module with electrical energy (or electrical power). The energy supply parameters concern, in such case, energy supply of the field device by the field device power supply module. The method of the invention comprises steps as follows:
A) operating the system comprising field device power supply module and connected field device with set energy supply parameters of the field device power supply module;
B) automated monitoring by the field device power supply module of the manner of operation of the connected field device to look for occurring malfunctions; and
C) automated diagnosing of incorrect settings of energy supply parameters by analyzing malfunctions occurring in the connected field device and associating these with incorrectly set energy supply parameters based on predetermined rules.

The method of the invention, thus, significantly facilitates for a user (or, in given cases, also for a service specialist) the ascertaining of a source of malfunction in the case of occurrence of a malfunction of the field device. As is explained above, especially the setting of energy supply parameters of a field device power supply module (especially a wireless adapter) is error susceptible, since settings of the energy supply parameters have to be made as a function of the field device type of connected field device. In such case, the danger is great that, in the case of manual input by a user, the wrong settings (for example, those for another field device type) are ascertained and/or mistakes are made in the inputting of the settings,. The method of the invention permits, in relatively simple manner, through analysis of the respectively arising error, ascertaining whether and, in given cases, which one or more energy supply parameters is/are incorrectly set. Accordingly, costs and effort for ascertaining the source of a malfunction can be significantly reduced.

The field device power supply module need not absolutely be embodied as a wireless adapter. Rather, it can be, in general, a module, which is embodied for connection to a (single) field device and through which the one connected field device is suppliable with electrical energy (or electrical power). For example, instead of the previously frequently provided, direct connection of a field device to the grid current, it can also be provided that it is connected via a field device power supply module of the invention to the grid current or also to another energy source, which can be embodied externally of, and/or internally in, the field device power supply module, so that the field device is supplied with electrical energy by the field device power supply module. In this way, the electrical current supply can be optimally matched to the respective field device type. Correspondingly, consumption of electrical energy can be reduced. Besides the electrical current supply of the connected field device, the field device power supply module can also perform yet other functions.

In a field device power supply module, in such case, in corresponding manner, as this is explained above in reference to a wireless adapter, parameters are provided, through which a manner of operation of the field device power supply module is adjustable. The parameters are, in such case, especially stored in a memory of the field device power supply module, so that a control unit (e.g. a microprocessor) of the field device power supply module can access these parameters and operate the field device power supply module corresponding to the parameter settings. Especially, energy supply parameters are provided in the field device power supply module, wherein through the parameter setting of these energy supply parameters, the properties, or characterizing variables, of the energy supply (or electrical current supply) provided by the field device power supply module are adjustable.

The field device power supply module is, in such case, connected to exclusively one field device. Especially, it is not embodied for energy supply of a plurality of field devices connected in parallel. Accordingly, the energy supply parameters can also be set specially for the particularly connected field device type, so that its energy supply is optimized. Preferably, the field device power supply module is connected releasably to a field device. In this way, it is connectable, in simple manner, to different field devices, especially also to different field device types.

The energy supply parameters concern energy supply of the connected field device by the field device power supply module. Especially, these parameters permit the electrical energy (especially electrical power) provided by the field device power supply module to be matched to a power requirement of the field device type of the particularly connected field device and, in given cases, also to different operating phases of this field device type. Examples of energy supply parameters include, among others, electrical current values, voltage values and/or time periods (during which, for example, a certain voltage value is to be provided), etc.

In the case of the step of “operating” (step A)), such can comprise a continuous operation of the system composed of field device power supply module and connected field device. Especially, it includes a start-up, in the case of which the different operating phases run through by the field device during start-up can be monitored very well. Furthermore, it can be provided that the system composed of field device power supply module and field device is operated in use only clocked (e.g. only for a measured value query to a sensor or for an actuating command to an actuator) in an “on” state (in the case of which it, as a rule, passes through the different phases of start-up) and during the rest of the time is in an “off” state or in a sleep-mode (i.e. a mode with reduced energy consumption compared with the “on” state). Such clocked operation is advantageous as regards energy saving. Especially, when the field device power supply module is not connected to an external electrical current source, but, instead, has only an internal (i.e. autarkic) electrical current source, such a clocked operation is advantageous, since the life of the electrical current source is increased thereby.

In the case of clocked operation, the method of the invention is performed, for example, at least during the “on” states (and therewith in the case of each start-up of the field device). In the case of continuous operation, the method of the invention can be performed continuously, so that the manner of operation of the field device (compare step B)) is monitored continuously. Additionally or alternatively, the method of the invention can, however, also be performed upon explicit request of a user or a superordinated communication unit in communication with the field device power supply module. In this case, the system composed of field device and field device power supply module can also be placed in operation anew, so that the different operating phases of the field device are passed through anew.

To the extent that some steps of the method are said to be “automated”, this means that these are executed without human intervention, especially by soft- and/or hardware. In the method of the invention, especially the steps of monitoring and diagnosing (and therewith the steps of analyzing and associating) involve automated performance.

In the case of the step of automated diagnosing (step C), at least such incorrect settings of energy supply parameters can be ascertained, which lead to a defect of the field device (which includes a detectable malfunction of the field device). Included as “incorrect” are, in such case, especially settings of energy supply parameters, which lead in the case of the connected field device type to an error, even when these lead to no error in the case of another field device type.

In a further development, the field device power supply module is in the form of a wireless adapter, by which a wireless signal transmission is effected for the connected field device. In this way, a conventional field device can be retrofitted into a radio field device and simultaneously be operated in an energy saving manner. Especially, a wireless adapter can transmit, via radio, information of the field device (measured values, diagnostic information, status information, etc.) to a separately embodied unit, which is embodied for a corresponding wireless communication and which, in reference to the particular plant, executes process control, process monitoring, plant asset management and/or visualizing tasks, etc. Equally, the wireless adapter can receive telegrams from such unit. In such case, it can be provided that all communication for the field device is performed wirelessly by the wireless adapter. This is, however, not absolutely necessary. Rather, it can also be provided that a part of the communication occurs by wire. For example, it can be provided in the case of a HART® field device that a measured value is transmitted analogly via a wired communication connection according to the 4-20 mA-standard, while other information is transmitted wirelessly through the wireless adapter.

The wireless adapter can especially be embodied in such a manner that it forms a communication participant of a radio, or wireless, network according to the standard IEEE 802.15.4. The radio network can, furthermore, be embodied according to the wireless HART®-standard or according to the ISA100 standard, which, in each case, builds upon the standard IEEE 802.15.4. In the case of the said radio, or wireless, networks, the wireless adapter communicates, as a rule, with a gateway, which enables communication with a network superordinated to the radio network, a superordinated network such as, for example, a wired fieldbus, a company network (e.g. an Ethernet®-network), the Internet and/or a system communicating via GSM, etc. Connected to the superordinated network can be, for example, a superordinated unit, which provides process control, plant asset management system, a visualizing system, etc., so that communication is enabled between these and the field device (via the gateway and the wireless adapter). Alternatively to the above said standardized radio, or wireless, networks, however, also other radio, or wireless, networks can be applied. Additionally or alternatively, the wireless adapter can also be embodied in such a manner that it enables direct wireless communication (for example, via GSM, Bluetooth, wireless LAN, etc.). In this way, it can communicate wirelessly directly with a communication unit (e.g. a superordinated unit, which provides process control, plant asset management system, a visualizing system, a vendor asset management system, etc.), which requests, for example, a transmitted measured value or sends control commands to the wireless adapter, etc.

In a further development, the field device power supply module includes at least one autarkic, electrical current source. In this way, the system composed of field device and field device power supply module is operable decoupled from a grid current. If the field device power supply module is simultaneously embodied as a wireless adapter, then the system of field device and wireless adapter can be operated completely autarkically (i.e. without connection to an external electrical current grid and without wired connection to a fieldbus or to a network). This is especially advantageous in the case of exposed and/or difficultly accessible locations and/or locations exposed to extreme conditions of use in a plant. The field device power supply module can especially have a single-use battery, a rechargeable battery and/or a solar cell as the autarkic, electrical current source.

In a further development, the field device power supply module is connected to a communication interface of the field device. If the field device power supply module is embodied as a wireless adapter, then, for sending data via the fieldbus, these data are sent via the communication interface (wired) to the wireless adapter, which then transmits these via radio to the target location. Conversely, the wireless adapter can receive data via radio and forward such via the communication interface to the field device. In a further development, the communication interface is embodied as a fieldbus communication interface and communication therethrough occurs according to the respective fieldbus protocol. In such case, especially a standardized fieldbus system is suitable, such as, for example, Profibus® (compare Profibus Profile Specification, version 3.0) or Foundation® Fieldbus (compare Foundation® specification, Function Block Application Process, revision EN 1.7), wherein a fieldbus communication interface according to the HART®-standard (compare HART® Field Communication Protocol Specifications, revision 7.0) is preferable due to the frequent application of this fieldbus system and due to its good suitability for wireless communication. If the field device power supply module is embodied simultaneously as a wireless adapter, then preferably the wireless communication also occurs according to the respective fieldbus standard, according to which also the (wired) communication interface of the field device is embodied. In reference to the wired communication interface of the field device, the field device can be embodied as a 2 conductor device, which means that both the communication as well as also the energy supply (or electrical current supply) of the field device occurs via a shared 2 conductor connection. Furthermore, the field device can also be embodied as a 4 conductor device, which means that the communication occurs via one 2 conductor connection and the energy supply of the field device via another 2 conductor connection.

In a further development, the step of automated diagnosing (step C)), which includes the steps of analyzing and associating, is executed by the field device power supply module. In this way, the method of the invention can be executed completely in the field device power supply module. In this way, there is no dependence on external systems. Furthermore, performing the method is facilitated, since no communication with external systems is required for this. Alternatively, there is also the option to perform the step of diagnosing (step C)) completely or partially from an external communication unit, such as, for example, through a configuration unit or a handheld servicing device, which is connected for (wireless or wired) communication with the field device power supply module.

In a further development, at least one incorrectly set energy supply parameter, which was ascertained in the step of automated diagnosing (step C)), is provided, especially displayed, to a user via at least one of the following devices:
a) the field device power supply module;
b) a configuration unit, which is connected for communication with the field device power supply module; and/or
c) a handheld servicing device, which is connected to a service interface of the field device power supply module.

Preferably, there is provided for this on the respective device a display, on which the respective incorrectly set energy supply parameters (and, in given cases, other supplemental information) can be displayed. For example, the field device power supply module can have a display- and service unit, so that the respective information can be displayed directly on-site. In such case, information can also be provided on a plurality of the above set forth units (field device power supply module, configuration unit, handheld servicing device) and/or also on yet additional units, so that a user has a number of ways of obtaining the information.

A configuration unit and a handheld servicing device are applied for, among other purposes, setting and reading out parameters of an associated device (here: a field device power supply module). Furthermore, in the same way as is known in the case of field devices, a display- and service unit can be provided also on the field device power supply module, in order that, among others things, parameters of the field device power supply module can be set and are capable of being read out. Implemented in a configuration unit is, as a rule, a corresponding configuration tool. Such a configuration tool (e.g. FieldCare® of Endress+Hauser) offers, as a rule, much more functionality than a display- and service unit integrated into the respective device (e.g. the field device power supply module), such as, for example, more display options, status displays, evaluation options, a graphical user interface with corresponding menu guidance, etc. A configuration unit, on which the configuration tool is implemented, can be formed, for example, by a computer, which is connected (for example, via a HART® modem) directly to the field device power supply module. If the field device power supply module is simultaneously also embodied as a wireless adapter, then communication between the configuration unit and the wireless adapter can also occur wirelessly, for example, via a (wireless) fieldbus (and, in given cases, supplementally also via a network superordinated to the fieldbus), via GSM (Global System for Mobile communications), via Bluetooth, via wireless LAN (wireless Local Area Network), etc. A handheld servicing device can be connected directly to the respective device via a corresponding service interface of the device (here: The field device power supply module). The service interface can, in such case, be embodied separately from a wired communication interface (in given cases, fieldbus communication interface) of the field device power supply module serving for connection to a field device, or it can alternatively be integrated in such communication interface.

In a further development, for at least one incorrectly set energy supply parameter, which was ascertained in the step of automated diagnosing, a user is informed of a default setting. The default setting is, for example, a standard parameter setting, in the case of which a sufficient energy supply for a plurality of field device types is assured. Thus, the occurrence of malfunctions in the connected field device can, as a rule, be prevented, even when, therewith, most often, no optimum operation of the system (as regards energy saving and an as rapid as possible start-up) is possible.

In a further development, the field device power supply module has one or more of the following energy supply parameters (wherein the parameter designations correspond to the respective functions of the parameters):
a) a starting voltage, which is provided by the field device power supply module after turn-on of the field device for a (set) starting time;
b) a starting current, which gives the maximum, electrical current requirement of the field device during the (set) starting time;
c) a starting time, during which the (set) starting voltage is provided by the field device power supply module for the field device;
d) an operating voltage, which is provided by the field device power supply module after expiration of the (set) starting time for normal operation of the connected field device; and/or
e) a setup time period, which is the time period from the end of the (set) starting time up to the point in time, at which the field device delivers a valid measured value.

The setting of the starting time is, in such case, selected corresponding to the respective field device type in such a manner that it corresponds to the time period of a starting phase of the relevant field device type. The setting of the starting voltage is selected in such a manner that a sufficient voltage (for the respective field device type) is provided by the field device power supply module during the starting phase. After the starting phase, the field device switches to normal operation, in which it likewise requires a sufficiently high voltage, which can deviate from the voltage required during the starting phase. The voltage provided by the field device power supply module for the normal operation (that is after expiration of the starting time) is determined by the setting of the parameter “operating voltage”. The field device can, in such case, run through the starting phase and the switching to normal operation upon switch-on from an “off” state and/or from a sleep-mode. Especially, these phases can be run through upon each switch-on, when operation is, as above described, in a clocked mode. Depending on field device type, in such case, however, also other and/or further operating phases of the field device can be provided with corresponding voltage- and electrical current requirements. In corresponding manner, also provided in the field device power supply module can be other or further energy supply parameters, by which, in each case, an appropriate energy supply of the connected field device can be set for the various operating phases.

In a further development, a restart of the field device before expiration of the set starting time means a too low setting of the starting voltage. In an additional further development, a restart of the field device after expiration of the set starting time means a too low setting of the operating voltage.

In a further development, a restart of the field device after expiration of the set starting time for the case, in which the set operating voltage is lower than the set starting voltage, means a too low setting of the starting time. Furthermore, in the situation in which the set operating voltage is lower than the set starting voltage, the case can occur, in which, after expiration of the set starting time, still no communication (e.g. still no HART®-communication) is possible between the field device and the field device power supply module. In this case, according to a further development, it is likewise provided that such defective or impossible communication after expiration of the set starting time means a too low setting of the starting time. In a further development, a restart of the field device before expiration of the set starting time for the case, in which the set operating voltage is higher than the set starting voltage, means a too high setting of the starting time.

In an additional further development, at a point in time directly after expiration of the set setup time period, an absence of a measured value requested by the field device power supply module from the field device or the providing of an invalid measured value by the field device means a too low setting of the setup time period. This further development is especially applicable, when the connected field device is a sensor.

In the step of automated diagnosing (step C)), the case can occur, in which incorrect settings of a plurality of energy supply parameters can be associated with an arising error. In order to ascertain, which energy supply parameters are actually incorrectly set, in given cases, other steps must be performed, in order to detect or exclude a defective setting of one or more of the energy supply parameters in question.

In a further development, for the case, in which, in the step of automated diagnosing, both a defective setting of the starting time as well as also a defective setting of at least one additional energy supply parameter can be associated with an arising error, steps as follows are performed:
D) ascertaining the actual starting time of the connected field device;
E) comparing the ascertained actual starting time with the set starting time; and
F) determining, based on the comparison, whether the set starting time is incorrectly set.

These steps (steps D) to F)) are, in such case, especially performed by the field device power supply module. Upon determining an incorrectly set starting time, the at least one other energy supply parameter in question can also still be incorrectly set. This can be ascertained, for example, by subsequently correctly setting the starting time and bringing the system anew into operation and monitoring the manner of operation of the connected field device.

The actual starting time (in the case of step D)) is ascertained according to a further development by setting sufficiently high voltage values for starting voltage and the operating voltage as well as a sufficiently high starting time, switching the system composed of field device power supply module and connected field device on and ascertaining the time period from switch-on until the field device switches into normal operation.

In a further development, additional steps are performed as follows:
G) determining a minimal possible use temperature of the field device power supply module as a function of a voltage provided by the field device power supply module to the connected field device; and
H) reporting to a user, in case a use temperature of the field device power supply module nears the determined minimal possible use temperature and/or in case a malfunction occurs in the field device due to a subceeding of, or falling beneath, the determined minimal possible use temperature.

The steps of determining (step G)) and reporting (step H)) are, in such case, executed especially by the field device power supply module.

Through this further development, it is taken into consideration that, especially when the field device power supply module has an autarkic, electrical current source, such as, for example, a single-use battery or a rechargeable battery, a maximum voltage providable by the field device power supply module depends on the respective use temperature. The lower the use temperature, the lower, as a rule, is also the maximum voltage providable by the field device power supply module. Accordingly, as a function of the respective voltage to be provided, which is predetermined as a function of the operating phase, for example, by the setting of the parameter “starting voltage” and/or “operating voltage”, the minimal possible use temperature can be determined. Accordingly, a user can in the step of reporting (step H)) be warned early, when the use temperature nears the determined minimal possible use temperature (for example, in the case of subceeding, or falling beneath, a limit value selected as a function of the determined minimal possible use temperature). Furthermore, a user can be subsequently informed in the step of reporting (step H)) concerning the source of the malfunction, when a malfunction has occurred (e.g. a crash and a following restart of the field device) due to subceeding, or falling beneath, the determined minimal possible use temperature.

The present invention relates, furthermore, to a field device power supply module, which has an electrical energy source, or is connected to such, and which is embodied in such a manner that it is connectable to exclusively one field device, that it can supply a connected field device with electrical energy, that it has energy supply parameters, which concern energy supply of a connected field device by the field device power supply module, and that it can perform the method of the invention, in given cases, also according to one or more of the explained further developments and/or variants. Such a field device power supply module especially achieves the above explained advantages. Especially, the field device power supply module is embodied in such a manner, that it can perform the steps of automated monitoring (step B)) and automated diagnosing (step C)).

Other advantages and utilities of the invention will become evident based on the following description of examples of embodiments with reference to the appended drawing, the figures of which show as follows:

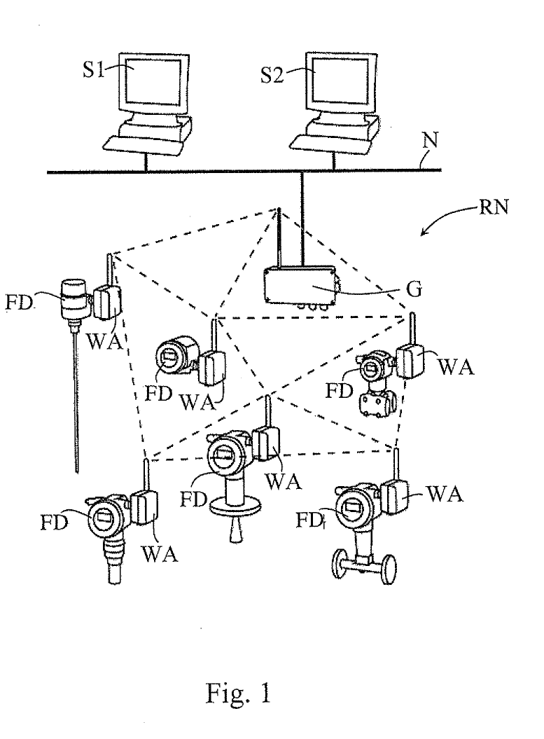

FIG. 1 a schematic representation of a part of an automated process plant with a radio network;

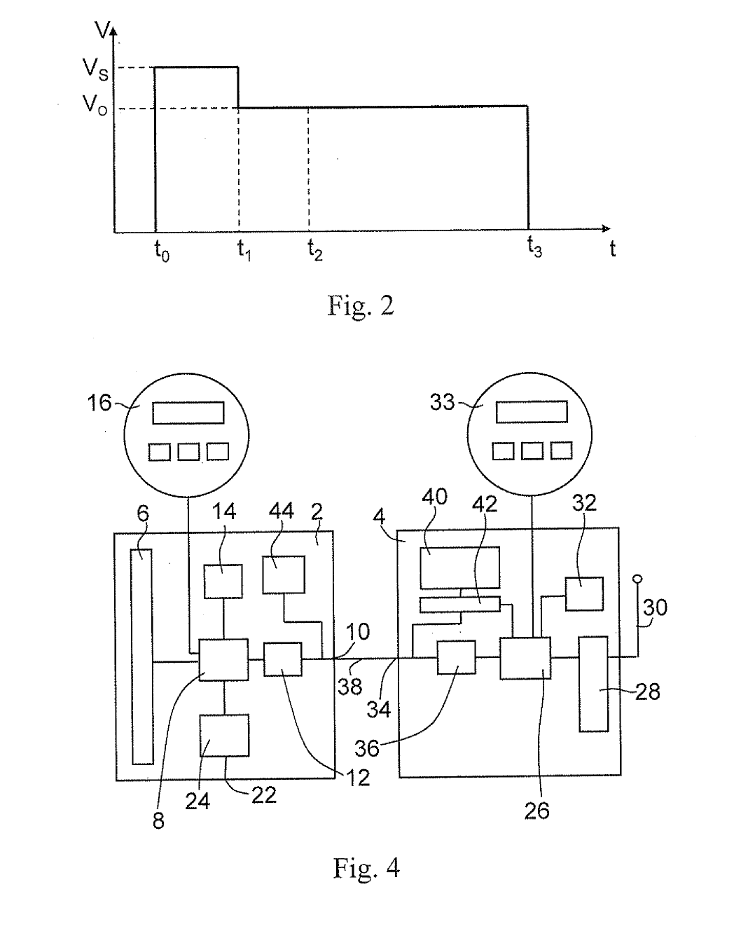

FIG. 2 a schematic diagram presenting, by way of example, voltage requirement as a function of time for a HART® field device of a first field device type;

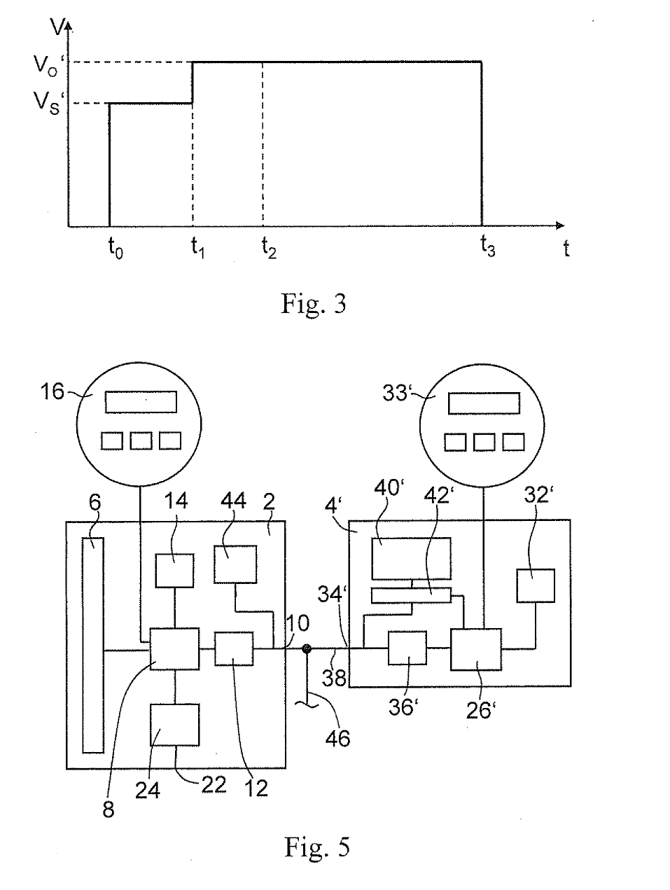

FIG. 3 a schematic diagram presenting, by way of example, voltage requirement as a function of time for a HART® field device of a second field device type;

FIG. 4 a block diagram of a field device and connected wireless adapter; and

FIG. 5 a block diagram of a field device and connected field device power supply module.

FIG. 1 shows schematically a part of an automated process plant with a radio network RN. The radio network RN includes a plurality of field devices ED with, in each case, a thereto connected wireless adapter WA, as well as a gateway G. The wireless adapters WA are connected by radio with one another and with the gateway G, this being indicated in FIG. 1 by the dashed lines. The radio network is embodied according to the wireless HART® standard. In the case of the illustrated example of an embodiment, the gateway (for example, the “Fieldgate” product of Endress+Hauser) is connected for communication with two servers S1 and S2 via a wired Ethernet®, company network N. The one server S1 forms simultaneously a superordinated unit, which, in reference to the field devices FD of the radio, or wireless, network RN, executes a process control. The other server S2 forms simultaneously a plant asset management system. Yet other (not shown) servers, fieldbus-systems, etc. can be connected to the company network N.

FIG. 2 shows, schematically, voltage requirement (voltage V as a function of time t) of a HART® field device of a first field device type, which, as shown in FIG. 1, is supplied with electrical energy by a wireless adapter and which is in the form of a sensor. The field device is in the case of the illustrated example of an embodiment clocked for the execution of a measured value request. In the periods of time, in which no measured value request is being processed by the field device, the system composed of wireless adapter and field device is switched off.

FIG. 2 shows the field device turned on at the point in time t₀. During a starting phase, the field device requires a starting voltage V_{S}. Furthermore, the field device requires a certain starting current, which can vary during the starting phase, depending on need. During the starting phase, the field device, for example, charges capacitors, performs self-checks, etc. Communication between the field device and the wireless adapter connected thereto is, however, still not possible. In the case of the illustrated example of an embodiment, the starting phase of the field device ends at the point in time t₁ and the field device then begins normal operation. Provided in the wireless adapter for the starting phase are the energy supply parameters, “starting voltage”, “starting time” and “starting current”, wherein the wireless adapter supplies the set starting voltage for the time period of the set starting time. For the energy supply parameter, “starting current”, there is set the maximum electrical current value, which the field device requires during the starting phase. This setting is especially required internally in the wireless adapter, in order to be able to provide the correct starting voltage.

These energy supply parameters, “starting voltage”, “starting time” and “starting current”, must be set in the wireless adapter, in such case, in such a manner that, during the starting phase, a sufficient energy supply of the field device is assured. If this is not the case, then especially a restart of the field device can occur. For example, a restart of the field device occurs before expiration of the set starting time (as a rule, relatively shortly after the point in time of the switching on t₀), when the energy supply parameter, “starting voltage”, is set too low. Accordingly, when such a restart of the field device occurs before expiration of the set starting time, it can be diagnosed that the starting voltage was set too low in the wireless adapter.

During normal operation, the field device requires an operating voltage V_{O}, which, in the illustrated example of an embodiment, is lower than the starting voltage V_{S}. In normal operation, communication of the field device via its HART® communication interface with the wireless adapter is possible. In normal operation, the HART® field device, which, in the present example of an embodiment, is in the form of a 2 conductor device, can be operated especially in a multidrop mode, in which the electrical current value is set at a fixed, as low as possible, electrical current value (e.g. 4 mA) and communication occurs exclusively digitally via the HART® communication interface. Alternatively, the HART® field device can, however, also be operated in a 4-20 mA mode, in which the electrical current value is set analogly (in known manner), in each case, corresponding to the measured value registered by the field device. Additionally, the 4-20 mA signal can be superimposed in known manner with a digital signal. In reference to the normal operational phase, there is provided in the wireless adapter the energy supply parameter, “operating voltage”, by which is gettable the voltage to be provided by the wireless adapter after expiration of the set starting time.

The energy supply parameter, “operating voltage”, must, in such case, be set in the wireless adapter in such a manner that, during normal operation, a sufficient energy supply of the field device is assured. If this is not the case, then a restart of the field device occurs (as a rule, directly or in a short time) after expiration of the set starting time. Accordingly, when such a restart of the field device occurs after expiration of the set starting time, it can be diagnosed that the operating voltage was set too low in the wireless adapter. Furthermore, in the case of the illustrated voltage requirement of the field device (V_{O} lower than V_{S}), the situation can occur, in which the starting time is set too low, so that, after expiration of the set starting time, then the lower operating voltage is being provided, although the field device, which is still located in the starting phase, has a higher voltage requirement. Also, in this case, a restart of the field device can occur. Accordingly, when such a restart occurs after expiration of the set starting time, it can be diagnosed that the starting time is set too low in the wireless adapter.

As evident from the two previously explained situations, a restart of the field device after expiration of the set starting time can mean both an operating voltage set too low as well as also a starting time set too low. In order to ascertain, which of these two energy supply parameters is actually set incorrectly, or whether it is perhaps both, especially the actual starting time of the connected field device can be ascertained by the wireless adapter. For this, there can be set in the wireless adapter sufficiently high voltage values for the starting voltage and the operating voltage (here, e.g., the previously set starting voltage or a still higher value) as well as a sufficiently long starting time. With these settings, the system composed of field device power supply module and connected field device is turned on and the time period from switch-on ascertained, until the field device switches into normal operation. When the field device is operated in normal operation in a multidrop mode, the switching into normal operation can be detected as that point in time when the electrical current value on the HART® communication interface of the wireless adapter moves from a needs dependent, electrical current value (which, as a rule, varies as a function of time) of the starting phase to a fixed, as low as possible, electrical current value (e.g. 4 mA). If the field device is operated in normal operation in a 4-20 mA mode, then the switching into normal operation can, as a rule, likewise be detected based on the electrical current value at the HART® communication interface. Additionally or alternatively, the switching into normal operation can be ascertained by finding the point in time, from which point on, a HART® communication between the field device and the wireless adapter via the HART® communication interface becomes possible. For this, for example, the wireless adapter can repeatedly send a query to the field device and the point in time ascertained, at which the field device answers for the first time. When the actual starting time of the connected field device has been ascertained, this is compared with the starting time set in the wireless adapter. If there is, in such case, a deviation detected, by which an insufficient energy supply of the field device is caused (here: starting time set too low), then it is determined therefrom that the starting time is incorrectly set.

Directly after switching into normal operation, the field device can still provide no measured value. For example, the field device still requires time to record one or more measured value(s), to perform calculations, etc. The time period, which passes after the switching into normal operation (point in time t₁) until the point in time, when the field device can provide a measured value (point in time t2), is referred to as the setup time period. Depending on field device type, this time period can vary between some seconds up to some minutes. In the wireless adapter, the energy supply parameter, “setup time period”, is provided, by which can be set the time period from the end of the starting time up to the point in time, at which the field device delivers a valid measured value. This setup time period must be set corresponding to the respective field device type. The setup time period is allowed by the wireless adapter to pass after switching of the field device into normal operation, before the wireless adapter queries the field device for a measured value. During such waiting time, the wireless adapter can be operated in an energy saving mode, whereby energy consumption is reduced. If a measured value query is issued by the wireless adapter to the field device before expiration of the actual setup time period of the connected field device, then, in response thereto, either no measured value or an invalid measured value (e.g. with a status “BAD”) is provided by the field device. Accordingly, when, at a point in time directly after expiration of the set setup time period, a measured value requested by the wireless adapter from the field device is absent or an invalid measured value is provided by the field device, a too low setting of the setup time period can be diagnosed. In the case of the situation illustrated in FIG. 2, at the point in time t3, the measured value query has been completely executed and the field device is switched back off.

FIG. 3 shows, schematically as a function of time, the voltage requirement of a HART® field device of a second field device type. In the following, primarily the differences compared with the voltage requirement explained with reference to FIG. 2 and the different diagnostic opportunities will be explored. It should be pointed out that reference is made to the description of FIG. 2, which can be correspondingly taken into consideration here.

In contrast to the voltage requirement illustrated in FIG. 2, in the case of the situation illustrated in FIG. 3, the required operating voltage V_{O}′ of the field device is higher than the required starting voltage V_{S}′. A too low setting of the starting voltage, a too low setting of the operating voltage as well as a too low setting of the setup time period can be detected, in such case, in manner corresponding to that explained above in reference to FIG. 2. In the case illustrated in FIG. 3 for the voltage requirement (V_{O}′ higher than V_{S}′), the situation can occur, in which the starting time is set too high and the field device switches into normal operation before expiration of the set starting time. Accordingly, after the switching, the starting voltage is still provided by the wireless adapter, although the field device already requires a higher operating voltage. In this way, a restart of the field device can occur. As a result, when such a restart occurs before expiration of the set starting time (however, as a rule, with a noticeable amount of time from the point in time of the switching on, t₀), a too high setting of the starting time can be diagnosed.

In the following with reference to the schematic block diagram of FIG. 4, by way of example, a field device 2 and a thereto connected, wireless adapter 4 will now be explained. Field device 2 is a sensor and embodied as a 2 conductor device. Especially, the system composed of field device 2 and wireless adapter 4 forms a system, such as is represented in FIG. 1, in each case, by the pairs formed of a field device FD and a wireless adapter WA.

Field device 2 includes a measured value transducer 6 and a control unit embodied in the form of microprocessor 8. Furthermore, field device 2 includes a wired HART® communication interface 10 connected to microprocessor 8. Associated with HART® communication interface 10 is a functional unit 12, which is formed by an ASIC (Application Specific Integrated Circuit) and which performs the sending and/or receiving of signals (corresponding to the HART® standard) via the HART® communication interface 10. Via the HART® communication interface 10, field device 2 could, alternatively to the illustrated connection to the wireless adapter 4, be connected to a wired HART® fieldbus system. Furthermore, field device 2 includes a data memory 14 and a display- and keypad unit 16. Furthermore, field device 2 is shown schematically to have a service interface 22, with which is associated a functional unit 24 in the form of an ASIC.

Wireless adapter 4 likewise includes a control unit in the form of a microprocessor 26. For data exchange over the radio network, microprocessor 26 is connected with a radio unit 28, which includes an RF chipset and an antenna 30. Radio unit 28 is, in such case, embodied in such a manner that the wireless communication occurs according to the wireless HART® standard. The microprocessor 26 is connected, furthermore, with a data memory 32. Stored in the data memory 32 are the parameter settings of the wireless adapter 4. The microprocessor 26 can access these parameter settings, in order to operate the wireless adapter 4 correspondingly to the parameter settings. The wireless adapter 4 includes, furthermore, a display- and keypad unit 33. For communication with the field device 2, the wireless adapter 4 includes a wired HART® communication interface 34, with which is associated a functional unit 36, which performs (according to the HART® standard) the sending and/or receiving of signals via the HART® communication interface 34. Functional unit 36 is provided in the form of an ASIC. The HART® communication interface 10 of the field device 2 and the HART® communication interface 34 of the wireless adapter 4 are connected with one another via a 2 conductor connecting line 38. Via this connection, there occurs both the communication between the field device 2 and the wireless adapter 4 as well as also the electrical current supply of the field device 2 by the wireless adapter 4. The wireless adapter 4 can thus provide wireless signal transmission for the connected field device 2.

For providing the electrical current supply of the field device 2 (and of the wireless adapter 4), the wireless adapter 4 includes an electrical current source in the form a single-use battery 40 and a power supply 42 connected to the single-use battery 40. Power supply 42 supplies (via electrical current supply lines, which are not shown) electrical energy (or electrical power) to the system components of the wireless adapter 4 as well as to the system components of the field device 2 via the HART® communication interface 34, the 2 conductor connecting line 38, the HART® communication interface 10 and a thereto connected power supply 44 of the field device 2. In such case, the individual power supplies 42 and 44 can also, in each case, be divided into a number of power supply stages. The power supply 42 of the wireless adapter 4 is, in such case, operated by the microprocessor 26 in correspondence with the parameter settings of the energy supply parameters. Thus, the power supply 42 provides energy corresponding to the parameter settings.

A field device 2 and a thereto connected field device power supply module 4′ will now be explained with reference to FIG. 5, by way of example, based on its schematic block diagram. Primarily differences compared with the arrangement illustrated in FIG. 4 will be explained. Field device 2 here is constructed like that illustrated in FIG. 4, so that, in turn, the same reference characters are used. Field device power supply module 4′, in contrast to the wireless adapter 4 of FIG. 4, here provides no wireless signal transmission for the field device 2. Accordingly, field device power supply module 4′ has no radio unit and no antenna. Field device power supply module 4′ is constructed in manner corresponding to the wireless adapter 4 of FIG. 4. Especially, it includes a microprocessor 26′, a data memory 32′, a display- and keypad unit 33′, a HART® communication interface 34′, a functional unit 36′ associated therewith, a single-use battery 40′ and a power supply 42′. The HART® communication interface 10 of the field device 2 and the HART® communication interface 34′ of the field device power supply module 4′ are, again, connected with one another via a 2 conductor connecting line 38, so that communication according to the HART® standard is possible between the field device 2 and the field device power supply module 4′. In order, in the context of process control, to be able to communicate with a superordinated unit, the field device 2 is connected via its HART® communication interface 10 in the illustrated example of an embodiment, furthermore, by wire to a fieldbus, this being illustrated schematically in FIG. 5 by the branch 46 from the 2 conductor connecting line 38.

1-15. (canceled)

16. A method for the diagnosis of incorrect settings of energy supply parameters of a field device power supply module, which is connected to exclusively one field device and includes an electrical energy source or is connected to such, wherein the field device power supply module supplies the one connected field device with electrical energy, and wherein the energy supply parameters concern energy supply of the field device by the field device power supply module, the method comprises steps of:
operating the system comprising field device power supply module and connected field device with set energy supply parameters of the field device power supply module;
automated monitoring by the field device power supply module of the manner of operation of the connected field device to look for occurring malfunctions; and
automated diagnosing of incorrect settings of energy supply parameters by analyzing occurring malfunctions and associating these with incorrectly set energy supply parameters based on predetermined rules.

17. The method as claimed in claim 16, wherein:
the field device power supply module is in the form of a wireless adapter, by which a wireless signal transmission is effected for the connected field device.

18. The method as claimed in claim 16, wherein:
the field device power supply module includes at least one autarkic, electrical current source, especially a single-use battery, a rechargeable battery and/or a solar cell.

19. The method as claimed in claim 16, wherein:
the field device power supply module is connected to a communication interface of the field device.

20. The method as claimed in claim 16, wherein:
said step of automated diagnosing is executed by the field device power supply module.

21. The method as claimed in claim 16, wherein:
at least one incorrectly set energy supply parameter, which was ascertained in the step of automated diagnosing, is provided to a user via at least one of the following devices:
a) the field device power supply module;
b) a configuration unit, which is connected for communication with the field device power supply module; and/or
c) a handheld servicing device, which is connected to a service interface of the field device power supply module.

22. The method as claimed in claim 16, wherein:
the field device power supply module has one or more of the following energy supply parameters:
a) a starting voltage, which is provided by the field device power supply module after turn-on of the field device for a starting time;
b) a starting current, which gives the maximum electrical current requirement of the field device during the starting time;
c) a starting time, during which the starting voltage is provided by the field device power supply module for the field device;
d) an operating voltage, which is provided by the field device power supply module after expiration of the starting time for normal operation of the connected field device; and/or
e) a setup time period, which is the time period from the end of the starting time up to the point in time, at which the field device delivers a valid measured value.

23. The method as claimed in claim 22, wherein:
a restart of the field device before expiration of the set starting time means a too low setting of the starting voltage.

24. The method as claimed in claim 22, wherein:
a restart of the field device after expiration of the set starting time means a too low setting of the operating voltage.

25. The method as claimed in claim 22, wherein:
a restart of the field device after expiration of the set starting time for the case, in which the set operating voltage is lower than the set starting voltage, means a too low setting of the starting time.

26. The method as claimed in claim 22, wherein:
a restart of the field device before expiration of the set starting time for the case, in which the set operating voltage is higher than the set starting voltage, means a too high setting of the starting time.

27. The method as claimed in claim 22, wherein:
at a point in time directly after expiration of the set setup time period, an absence of a measured value requested by the field device power supply module from the field device or the providing of an invalid measured value by the field device means a too low setting of the setup time period.

28. The method as claimed in claim 16, wherein:
for the case, in which, in said step of automated diagnosing, both a defective setting of the starting time as well as also a defective setting of at least one additional energy supply parameter can be associated with an arising error, the following steps:
ascertaining actual starting time of the connected field device;
especially by setting sufficiently high voltage values for starting voltage and the operating voltage as well as a sufficiently high starting time, switching the system composed of field device power supply module and connected field device on is and ascertaining time period from switch-on until the field device switches into normal operation;
comparing the ascertained actual starting time with the set starting time; and
determining, based on the comparison, whether the set starting time is incorrectly set.

29. The method as claimed in claim 16, further comprising the steps of:
determining a minimal possible use temperature of the field device power supply module as a function of a voltage provided by the field device power supply module to the connected field device; and
reporting to a user, in case a use temperature of the field device power supply module nears the determined minimal possible use temperature and/or in case a malfunction occurs in the field device due to a subceeding, or falling beneath, the determined minimal possible use temperature.

30. A field device power supply module, which has an electrical energy source, or is connected to such, and which is embodied in such a manner, that:
it is connectable to exclusively one field device;
it can supply a connected field device with electrical energy;
it has energy supply parameters, which concern energy supply of a connected field device by the field device power supply module, and
it can perform the method comprising the steps of:
a method for the diagnosis of incorrect settings of energy supply parameters of a field device power supply module, which is connected to exclusively one field device and includes an electrical energy source or is connected to such, wherein the field device power supply module supplies the one connected field device with electrical energy, and wherein the energy supply parameters concern energy supply of the field device by the field device power supply module, the method comprises steps of: operating the system comprising field device power supply module and connected field device with set energy supply parameters of the field device power supply module; automated monitoring by the field device power supply module of the manner of operation of the connected field device to look for occurring malfunctions; and automated diagnosing of incorrect settings of energy supply parameters by analyzing occurring malfunctions and associating these with incorrectly set energy supply parameters based on predetermined rules.
